(19) United States
(12) Patent Application Publication
(10) Pub. No.: US 2015/0035671 A1
(43) Pub. Date: Feb. 5, 2015

(54) Intelligent Reset System and Method For Patient Monitoring Pad

(71) Applicant: Rondish Company Limited, Kwai Chung (CN)

(72) Inventor: Steven Alfred Williams, Kwai Chung (CN)

(21) Appl. No.: 14/450,198

(22) Filed: Aug. 1, 2014

Related U.S. Application Data
(60) Provisional application No. 61/938,850, filed on Feb. 12, 2014.
(60) Provisional application No. 61/861,266, filed on Aug. 1, 2013.

(51) Int. Cl. G08B 21/04; G08B 25/01; G08B 25/10

(52) U.S. Cl. CPC G08B 21/0461; G08B 25/10; G08B 25/016
USPC 340/539.1

(57) ABSTRACT

A system that includes at least one patient monitoring device and a central unit for receiving signals and alerting caregivers of alarm states can be reset at the patient monitoring device end utilizing the existing signaling mechanism. In the case of weight-change-triggered patient monitoring devices, such as bed or chair pads, when a caregiver or other user presses down and releases the top of the device in a pattern that conforms to certain time constraints, the patient monitoring device resets and exits the alarm state.

### CROSS-REFERENCE TO RELATED APPLICATIONS

This claims priority to U.S. Provisional Application Ser. No. 61/938,850, titled “Intelligent Reset System and Method For Patient Monitoring Pad,” filed Feb. 12, 2014, and to U.S. Provisional Application Serial Number 61/861,266, titled “Intelligent Reset System and Method For Patient Monitoring Pad,” filed Aug. 1, 2013. The disclosure of each of the aforementioned applications is hereby incorporated by reference in its entirety herein.

### BACKGROUND

Cordless patient monitors are being used more in the patient care industry. As shown in FIG. 1, such patient monitors are often in the form of a bed pad that is communicatively linked with an individual patient monitor main unit located at the bed itself. Each patient monitoring pad has a dedicated patient monitoring pad monitor.

However, newer patient monitoring systems often employ several patient monitoring pads that each sends a monitoring signal directly to a central monitoring system via a wireless link, with the pads directly transmitting a signal to the central unit, as shown in FIG. 2. Such a configuration eliminates the patient monitor main unit and consequently saves the cost of the patient monitor main unit and makes the environment quieter. However, this configuration can lack an easy way to reset an alarm at the monitored point, such as the patient's bed or chair. In such a wireless configuration, the care worker may be required to go to the central station to reset the alarm or search for a hidden reset button at the monitored point. The configuration with an alarm reset only at the central monitor main unit can be especially cumbersome for alarms on moving monitored points, such as wheelchairs, wheeled beds or gurneys, and the like.

### SUMMARY

Disclosed is a patient monitoring system that includes at least one patient monitoring pad and a central monitoring station that communicate wirelessly, in which an alarm may be reset at the location of the patient monitoring pad. Provided in some embodiments is a system that include a patient monitor configured to wirelessly communicate with one or more patient sensors and a patient monitoring pad. The patient monitoring pad may be configured to wirelessly communicate with the patient monitor. The patient monitoring pad may also be configured to reset after an alarm by pressing and releasing in rapid succession on the patient monitoring pad within a predetermined amount of time.

The following features may be present in the system in any suitable combination. The system may further include a nurse call system communicatively connected to the patient monitor. The predetermined amount of time may be 2 to 5 second in some embodiments. The patient monitoring pad may include a bed pad or a chair pad.

In a related aspect, a method for resetting a patient monitoring pad at the monitoring site may be provided by some embodiments. The method includes detecting an alarm state, sounding an alarm, and pressing and releasing the patient monitoring pad quickly in a first predetermined amount of time.

The following features may be present in the method in any suitable combination. The method may also include starting a timer and waiting for it to run out, the timer set for a second predetermined amount of time. The first predetermined amount of time may be 2 to 5 seconds, in some embodiments.

Other features and advantages should be apparent from the following description of various embodiments, which illustrate, by way of example, the principles of the disclosure.

### BRIEF DESCRIPTION OF THE DRAWINGS

FIG. 1 shows patient monitoring pad linked to a main unit.

FIG. 2 shows a several patient monitoring pads linked to a central unit.

FIG. 3 shows a caregiver resetting a patient monitoring device.

FIGS. 4A-4D show exemplary methods, including those for resetting an alarm triggered by a patient leaving a patient monitoring pad.

### DETAILED DESCRIPTION

Disclosed are a system and method that permit a caregiver, such as a nurse, to reset a patient monitoring device at a monitored point, such as bed or wheelchair pad, without having to directly access a central unit at a monitoring station. In an embodiment, the caregiver resets the device, such as the pad, by pressing and releasing the device once, or several times, quickly. Advantageously, no additional equipment is required to reset the patient monitoring device and the caregiver does not have to search for an obscured, or difficult to reach, button or switch to achieve reset. The disclosed system and method provide a simple way to reset a weight-change-triggered patient monitoring device, such as a bed pad.

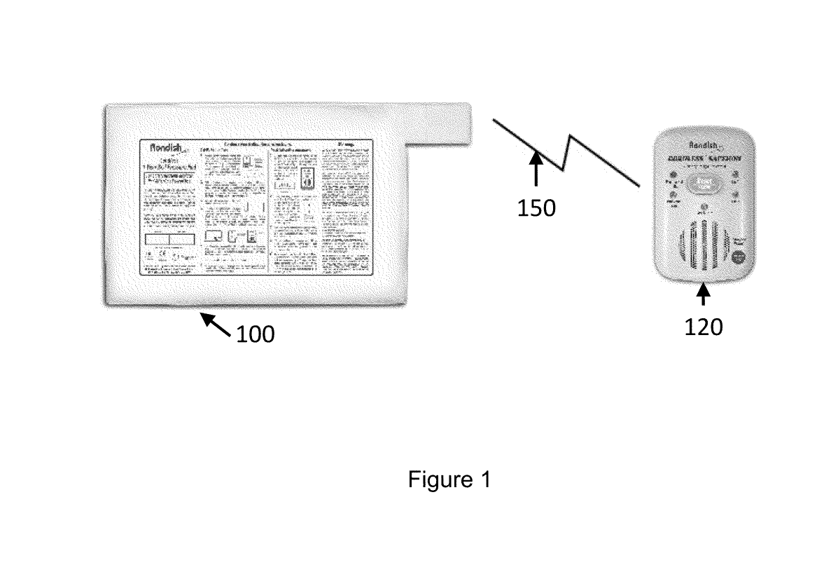

FIG. 1 shows a patient monitoring device 100 that wirelessly communicates with a monitoring unit 120 that is at a monitored point. In this case, that patient monitoring device 100 is a bed pad, the monitored point is the patient's bed, and the monitoring unit 120 can be located at the head or side of the bed, near the nurse call button. Such a system, with the monitoring device 100 communicating locally to a monitoring unit 120 that can in turn communicate with a centralized monitoring unit (e.g., a nurse call system), can be cumbersome because of signal passing and connections which need to be made and maintained. These systems can create noisy areas when several patient beds or other monitored points are in a single room and an alarm state is entered by one of the monitoring units at the monitored points. However, the presence of the monitoring unit 120 at the monitored points allows a caregiver, such as a nurse, the ability to quickly discern whether an alarm situation exists while terminating the alarm, if appropriate.

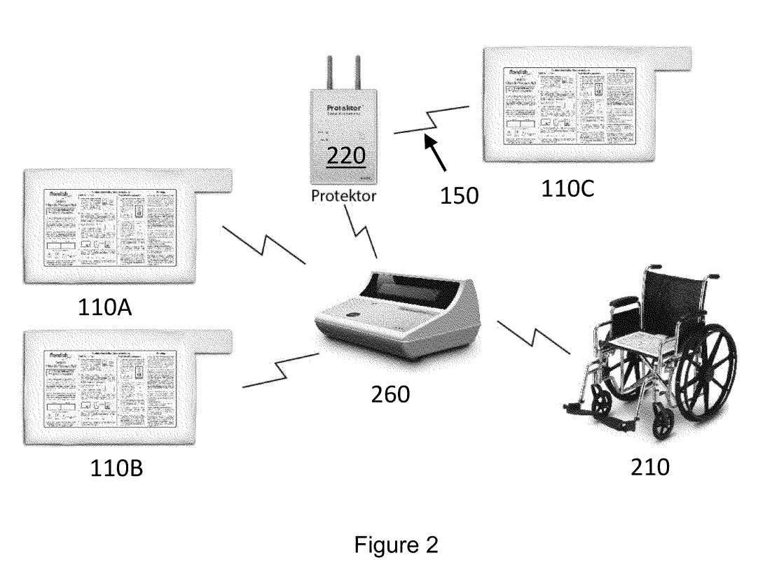

FIG. 2 shows several patient monitoring devices 110A, 110B, 210 linked directly to a central unit 260. In this figure, the patient monitoring devices are patient monitoring bed 110A, 110B and chair pads 210. In such systems, the central unit 260 can be located near one or more caregivers, such as at a nurses' station. The central unit 260 can be integrated into existing nurse call systems. In the figure, one of the patient monitoring bed pads 110C communicates with the central unit 260 through a wireless nurse call system 220. When the patient monitoring devices 110A, 110B, 210 communicate directly with the central unit 260, as in FIG. 2, monitoring units at the monitored points can be eliminated. This means that monitoring units at each bed or chair are not necessary.

The elimination of monitoring units at each bed or chair can provide a quieter environment in configurations with multiple patients in one room, as well as reducing costs. However, there can be the aforementioned difficulty in resetting a patient monitoring device after it has entered an alarm situation, or state, when the monitoring unit at each monitored point has been eliminated. In such situations, the reset button or switch that will terminate an alarm situation, or state, can be difficult to access on the patient monitoring device. This difficult access is intentional, so that the alarm situation or state cannot be inadvertently terminated prematurely. It is possible to terminate the alarm situation or state from the central unit, but a caregiver would verify the situation at the monitored point first, before resetting the alarm, and so either much travel between the central unit and the monitored point is needed to reset the alarm, or a knowledge of, or search for, the location of the reset button or switch on the patient monitoring device is needed.

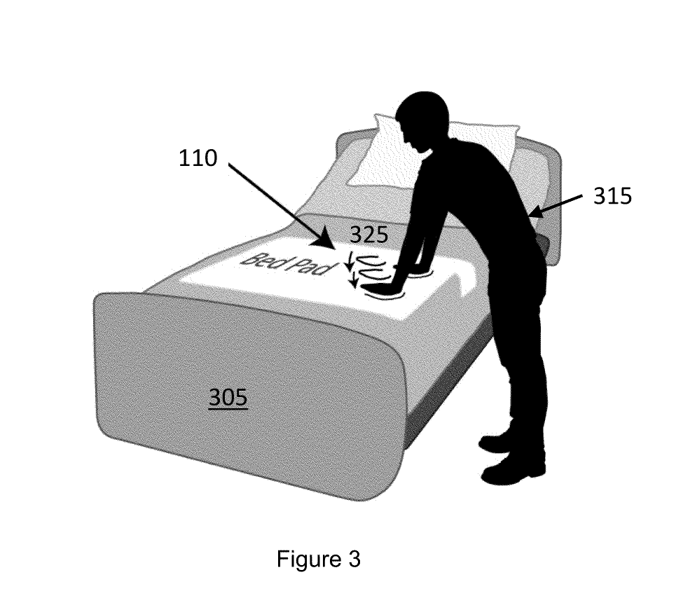

An alternate system and method for resetting a patient monitoring device is shown in FIG. 3. FIG. 3 shows a caregiver 315 resetting a weight-change-triggered patient monitoring device 110 at a monitored point 305. In the figure, the monitored point 305 is a patient bed and the patient monitoring device 110 is a bed pad. Such a bed pad can operate by detecting the electrical state of circuits within the pad, such as whether each circuit is open or closed, as well as (or alternatively) the resistance in each circuit. The electrical state of the circuits in the bed pad can change with the application or removal of pressure on the bed pad. Such bed pads and their operation are described in greater detail elsewhere, such as in U.S. patent application Ser. No. 12/606,043, published as U.S. 2010-0163315, and U.S. patent application Ser. No. 14/075,133, published as U.S. 2014-0125486, the disclosures of which are hereby incorporated by reference, each in their entirety.

When the caregiver 315 in FIG. 3 attends to an alarm situation, such as when the patient monitoring pad 110 has emitted an alarm, the caregiver 315 resets the patient monitoring device by directly accessing the patient monitoring pad. For example, the caregiver simply presses and releases 325 the pad 110 with a short press once, twice or more times. This feature is especially useful in the case of monitored points that are not stationary, such as wheelchairs. The alarms that may be controlled by resetting the patient monitoring pad by pressing and depressing may also include a wireless signal is sent directly to pager carried by the care giver. The transmitter may continually send a repeat signal to the care giver's pager at preset intervals, such as every 20 seconds.

As a feedback to the caregiver 315 that the reset is successful, the local receiver, or zone protector, can emit a short feedback sound, for example two beeps, or send a message sent to the caregiver's mobile device (e.g. pager or phone) that the unit has been reset. Feedback to the caregiver 315 can also include visual feedback, haptic feedback, or a combination of any of visual, audio, and haptic feedback. Visual feedback can include blinking or flashing lights, including small light bulbs or light emitting diodes (LEDs), messages on devices, screens, or liquid crystal displays (LCDs), or the like. Haptic feedback can include vibrations, such as a series of short vibratory bursts.

In the case of bed and chair pads, which are triggered initially by changes in pressure or weight on the pad, pressing and releasing the pad in a time-constrained or recognized pattern (e.g. rhythmically within a predetermined time) utilizes the existing signal generating mechanism in the patient monitoring device and the determination that the alarm state should be reset, or canceled, can be made either on the patient monitoring device itself or at the central unit that receives the signals. It should be appreciated that the press and release action is simply an example and that other actions may be used to reset the alarm. Other actions that may be used include those that utilize the existing signaling or status monitoring mechanisms of a patient monitoring device. The time constraints on the actions that may be used to reset the alarm can be indicative of purposeful action that is distinct from a patient vacating a monitored point, such a short time period between successive actions or a short duration (e.g. 2-5 seconds) of a state which a patient is normally in for longer periods of time (e.g. 30 seconds to many tens of minutes).

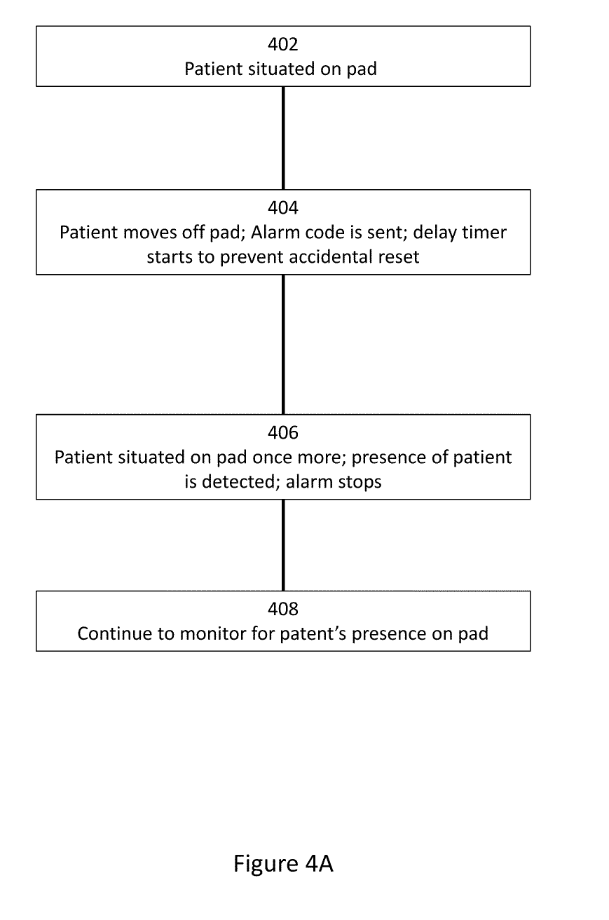

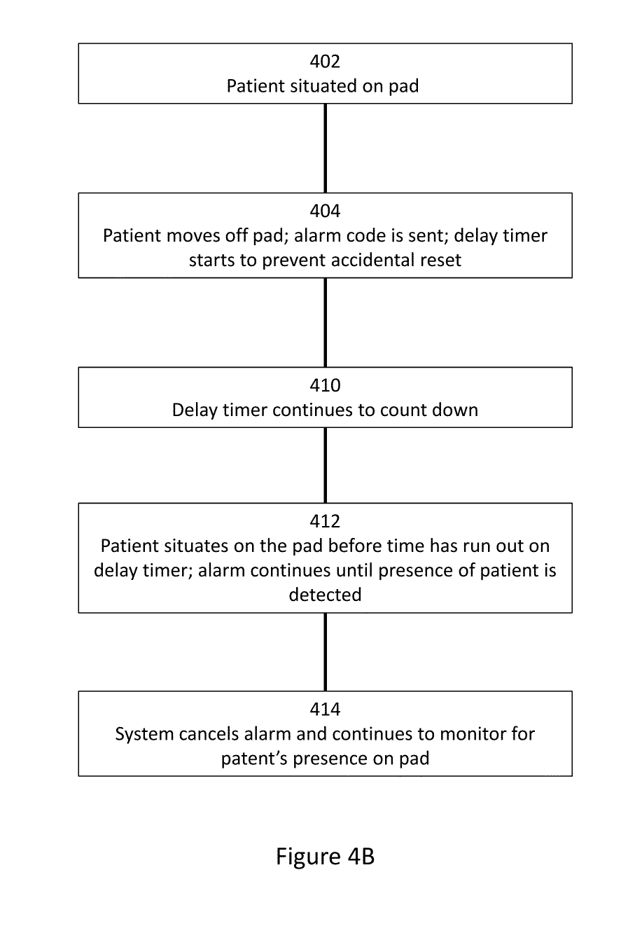

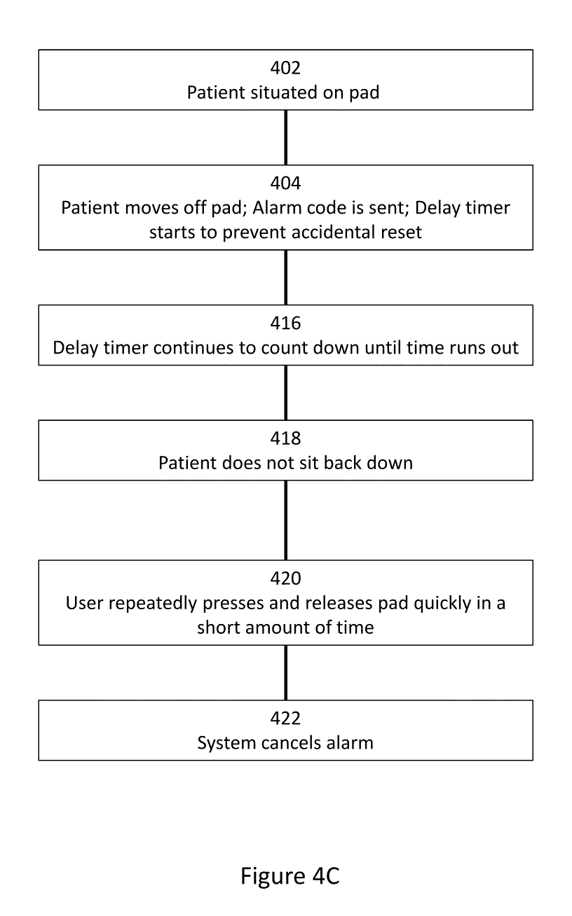

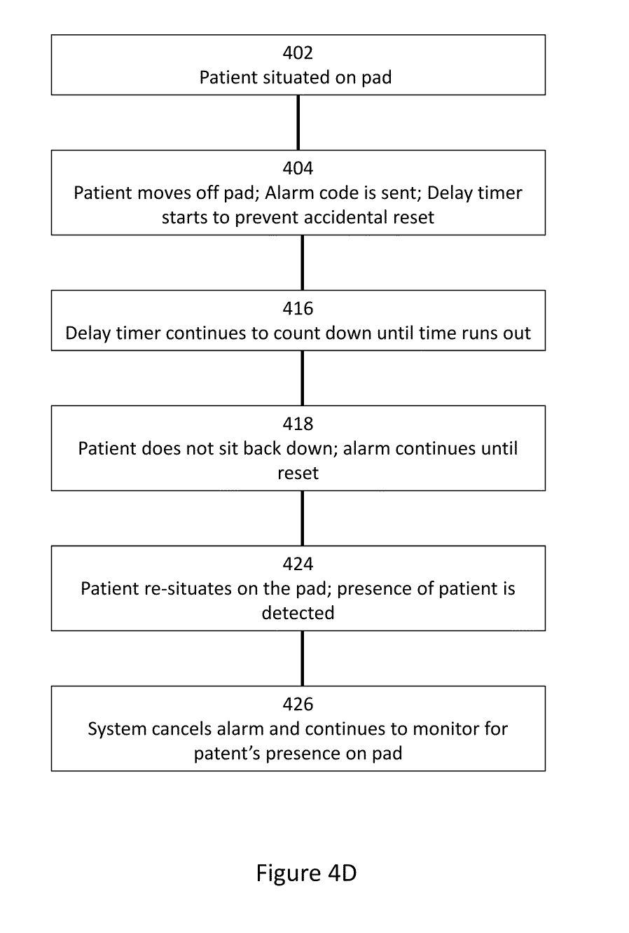

In a non-limiting example, a wheelchair has emitted an alarm. The caregiver attends to the alarm by going to the wheelchair location. The caregiver can reset the alarm by pressing and releasing the pad twice quickly (such as within 2-3 seconds). As mentioned, other actions for resetting the alarm can be used. The transmitter on the wheelchair then sends a reset signal to cancel the alarm on the system. In order to make sure a real alarm is not accidentally reset when a person leaves a bed pad (or other monitor) and presses and releases the pad accidentally there is a sequence of operation that prevents such an inadvertent alarm or an unintentional cancellation of an alarm. This is shown in the flow diagram of FIGS. 4A-4D.

FIG. 4A shows a method in which a patient temporarily removes him- or herself from a patient monitoring pad. Initially, the patient sits or lays on the patient monitoring pad, as in 402. If the pad is a bed pad, the patient may be laying down or sitting up in bed. Should the pad be a chair pad, the patient may be sitting in a wheelchair. At some point, the patient moves him- or herself off of the monitoring pad, as in 404, and an alarm code immediately activates. A delay timer starts counting down once the patient moves off the pad. This delay timer counts down a predetermined amount of time during which a reset at the monitoring pad is not allowed. For example, when a patient gets off the pad, and then perhaps quickly sits down on the pad before sliding off the pad once more, such as falling to the floor. In this case, the alarm would continue, and the motion of the patient will not unintentionally turn off the alarm.

When the patient sits or lays on the pad once more before the timer countdown completes, as in 406, the circuitry in the pad detects the presence of the patient. The persistent presence of the patient on the monitoring pad stops the alarm. The pad then continues to monitor the patient's presence on the pad, as in 408.

FIG. 4B shows another method in which a patient temporarily removes him- or herself from a patient monitoring pad. As in FIG. 4A, initially, the patient sits or lays on the patient monitoring pad, as in 402. If the pad is a bed pad, the patient may be laying down or sitting up in bed. Should the pad be a chair pad, the patient may be sitting in a wheelchair. At some point, the patient moves him- or herself off of the monitoring pad, as in 404, and an alarm code immediately activates. A delay timer starts counting down once the patient moves off the pad. The delay timer continues to count down until a persistent presence of the patient is detected, as in 410. When the patient sits or lays on the pad once more before the timer countdown completes, as in 412, the circuitry in the pad sends an alarm stopping signal to the central monitoring system. The pad then continues to monitor the patient's presence on the pad, as in 414. This method is a variation from the method show in FIG. 4A, in that the patient may not immediately situate him-or herself back on the monitoring pad. When a user tries to stop the alarm by resetting at the patient monitoring pad before the countdown timer finishes, the reset will not be effective. However, in all cases, once the patient monitoring pad detects a persistent presence of the patient, the alarm stops.

FIG. 4C shows a method in which a patient removes him- or herself from a patient monitoring pad and the system enters an alarm state. Initially, the patient sits or lays on the patient monitoring pad, as in 402. At some point, the patient moves him- or herself off of the monitoring pad, as in 404, and an alarm begins. A delay timer starts counting down once the patient moves off the pad, and the timer continues counting down until time runs out, as in 416. Within the time of the countdown, the patient has not returned to the pad, and the alarm continues until reset, as in 418. A user, such as a caregiver, investigates the patient's situation in response to the alarm. Once the caregiver addresses patient's situation, and the patient is no longer in danger of increasing harm by being ignored, the user (e.g., caregiver) resets the monitoring pad using a series of presses and releases on the pad, perhaps in short succession or within a certain time period, as in 420. The system then cancels the alarm, as in 422, and the system goes back to monitoring the patient.

FIG. 4D shows another method in which a patient removes him- or herself from a patient monitoring pad and the system enters an alarm state. Initially, the patient sits or lays on the patient monitoring pad, as in 402. At some point, the patient moves him- or herself off of the monitoring pad, as in 404, and an alarm state begins. A delay timer starts counting down once the patient moves off the pad, and the timer continues counting down until time runs out, as in 416. Within the time of the countdown, the patient has not returned to the pad, and the alarm continues until reset, as in 418. As in FIG. 4C, the caregiver investigates the patient's situation in response to the alarm. This may include helping the patient back to bed or the wheelchair, as in 424. The pad detects the patient has returned in 424, and in 426, the system resets the alarm and resumes monitoring the patient's movements. In the method of FIG. 4D, the user does not need to press on or otherwise initiate a reset at the monitoring pad, as the persistent presence of the patient on the pad ends the alarm and resumes patient monitoring.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, methods of use, embodiments, and combinations thereof are also possible. Therefore the spirit and scope of the appended claims should not be limited to the description of the embodiments contained herein.

What is claimed is:

1. A system comprising:
a patient monitor configured to wirelessly communicate with one or more patient sensors; and
a patient monitoring pad configured to wirelessly communicate with the patient monitor, the patient monitoring pad further configured to reset after an alarm by pressing and releasing in rapid succession on the patient monitoring pad within a predetermined amount of time.

2. The system of claim 1, further comprising a nurse call system communicatively connected to the patient monitor.

3. The system of claim 1, wherein the predetermined amount of time is 2 to 5 seconds.

4. The system of claim 1, wherein the patient monitoring pad comprises a bed pad or a chair pad.

5. A method for resetting a patient monitoring pad at the monitoring site, the method comprising:
detecting an alarm state;
sounding an alarm; and
pressing and releasing the patient monitoring pad quickly in a first predetermined amount of time.

6. The method of claim 5, further comprising starting a timer and waiting for it to run out, the timer set for a second predetermined amount of time.

7. The method of claim 5, wherein the first predetermined amount of time is 2 to 5 seconds.
